(19) United States
(12) Patent Application Publication
(10) Pub. No.: US 2025/0348125 A1
(43) Pub. Date: Nov. 13, 2025

(54) ELECTRONIC APPARATUS AND PROGRAM

(71) Applicant: Panasonic Intellectual Property Management Co., Ltd., Osaka (JP)

(72) Inventors: Ryuya YAMAMOTO, Osaka (JP); Kazuya TAKEISHI, Hyogo (JP); Yudai YAMAGUCHI, Osaka (JP)

(73) Assignee: Panasonic Intellectual Property Management Co., Ltd., Osaka (JP)

(21) Appl. No.: 19/276,497

(22) Filed: Jul. 22, 2025

Related U.S. Application Data
(63) Continuation of application No. PCT/JP2024/000407, filed on Jan. 11, 2024.

(30) Foreign Application Priority Data
Feb. 27, 2023 (JP) 2023-028690

(51) Int. Cl. G06F 1/3206; G06F 1/16; G06F 1/3287

(52) U.S. Cl. CPC G06F 1/3206; G06F 1/1633; G06F 1/3287

(57) ABSTRACT

An electronic apparatus in which two housings are rotatably connected and an opened and closed state corresponding to rotation is switchable, includes: a magnetism generation source provided in one of the housings; a magnetic sensor provided in the other housing, and disposed to be able to detect magnetism from the magnetism generation source in a closed state in which each of the housings approaches each other by rotation; a control circuit that determines whether the two housings are in the closed state based on at least a detection result of magnetism by the magnetic sensor; and a detector that is provided in one of the two housings, and detects, separately from the magnetic sensor, a state that changes according to whether the two housings are in the closed state.

### TECHNICAL FIELD

The present invention relates to an electronic apparatus in which two housings are rotatably connected and an opened and closed state corresponding to rotation can be switched, and to a program for operating such an electronic apparatus.

### BACKGROUND ART

PTL 1 discloses a technique for detecting an opened and closed state of a pair of housings openably and closably coupled to each other in a foldable electronic apparatus such as a mobile phone. The electronic apparatus of PTL 1 includes two opened and closed state detection means (a magnetic sensor, and an illuminance sensor, a pressure sensor, or the like) whose detection methods are different from each other. In a case where a detection result by at least one of the detection means indicates an opened state, it is determined that the housings are in the opened state, and in a case where detection results by both of the detection means indicate a closed state, it is determined that the housings are in the closed state. Accordingly, in the electronic apparatus, erroneous detection of a folded state is suppressed, and the convenience of the user is improved.

### CITATION LIST

### Patent Literature

PTL 1: Unexamined Japanese Patent Publication No. 2010-074206

### SUMMARY OF THE INVENTION

An object of the present disclosure is to provide an electronic apparatus and a program capable of accurately determining a closed state while suppressing erroneous determination of the closed state in which two housings approach each other by rotation.

In an electronic apparatus according to one aspect of the present invention, two housings are rotatably connected, and an opened and closed state corresponding to rotation is switchable. The electronic apparatus includes a magnetism generation source, a magnetic sensor, a control circuit, and a detector. The magnetism generation source is provided in one of the two housings. The magnetic sensor is provided in the other housing different from the one of the two housings, and is disposed to be able to detect magnetism from the magnetism generation source in a closed state in which the two housings approach each other by rotation. The control circuit determines whether the two housings are in the closed state based on at least a detection result of magnetism by the magnetic sensor. The detector is provided in one of the two housings, and detects, separately from the magnetic sensor, a state that changes according to whether the two housings are in the closed state. When magnetism is detected by the magnetic sensor, the control circuit determines that the two housings are in the closed state in a case where a detection result by the detector indicates a predetermined state corresponding to the closed state, and determines whether the two housings are in the closed state according to a detection period during which magnetism is continuously detected by the magnetic sensor in a case where a detection result by the detector indicates a state different from the predetermined state.

A program according to one aspect of the present invention controls an electronic apparatus in which two housings are rotatably connected and an opened and closed state corresponding to rotation is switchable. The electronic apparatus includes a magnetism generation source, a magnetic sensor, a control circuit, and a detector. The magnetism generation source is provided in one of the two housings. The magnetic sensor is provided in the other housing different from the one of the two housings, and is disposed to be able to detect magnetism from the magnetism generation source in a closed state in which the two housings approach each other by rotation. The control circuit executes the program to determine whether the two housings are in the closed state based on at least a detection result of magnetism by the magnetic sensor. The detector is provided in one of the two housings, and detects, separately from the magnetic sensor, a state that changes according to whether the two housings are in the closed state. When magnetism is detected by the magnetic sensor, the program causes, when executed by the control circuit, the control circuit to determine that the two housings are in the closed state in a case where a detection result by the detector indicates a predetermined state corresponding to the closed state, and determine whether the two housings are in the closed state according to a magnetism detection period by the magnetic sensor in a case where a detection result by the detector indicates a state different from the predetermined state.

According to the electronic apparatus and the program of the present disclosure, it is possible to accurately determine the closed state while suppressing erroneous determination of the closed state in which the two housings are close to each other by rotation.

### BRIEF DESCRIPTION OF THE DRAWINGS

FIG. 1 is a schematic perspective view of a PC in an opened state according to a first exemplary embodiment of the present disclosure.

FIG. 2 is a schematic perspective view of the PC in a closed state.

FIG. 3 is a block diagram illustrating an internal configuration of the PC.

FIG. 4 is a flowchart indicating a closed state determination process of the PC of the first exemplary embodiment.

FIG. 5 is a diagram for describing an illuminance threshold in the closed state determination process.

FIG. 6 is a flowchart indicating a closed state determination process of a PC of a second exemplary embodiment.

FIG. 7 is a flowchart indicating a closed state determination process in a first modification.

FIG. 8 is a flowchart indicating a closed state determination process in a second modification.

### DESCRIPTION OF EMBODIMENT

Hereinafter, exemplary embodiments of the present disclosure will be specifically described with reference to the drawings.

### First Exemplary Embodiment

In a first exemplary embodiment, a laptop personal computer (PC) will be described as an example of an electronic apparatus according to the present disclosure.

### 1. Configuration

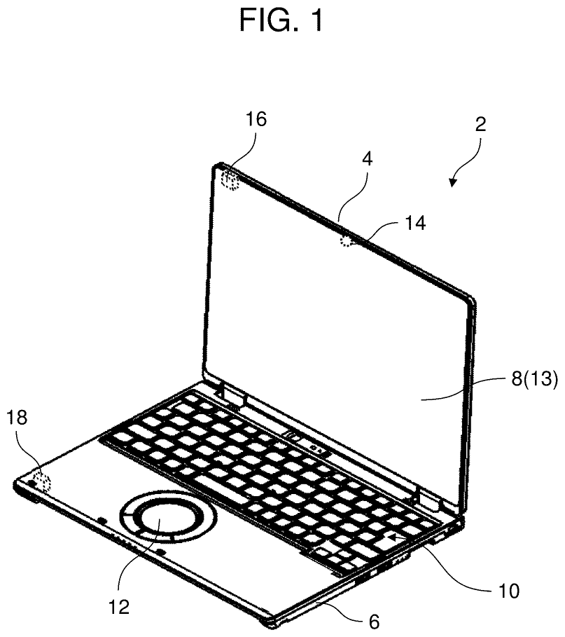

A configuration of the PC in the present exemplary embodiment will be described with reference to FIGS. 1 to 3.

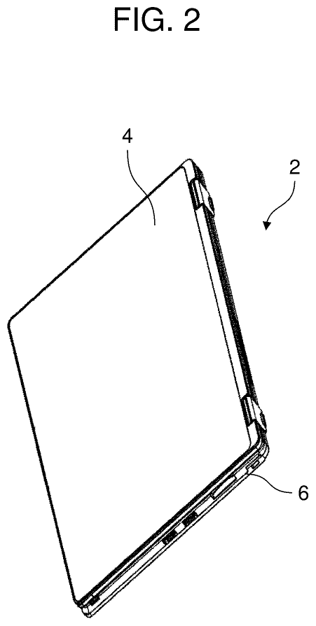

FIG. 1 is a schematic perspective view of PC 2 in an opened state according to the first exemplary embodiment. FIG. 2 is a schematic perspective view of PC 2 in a closed state. PC 2 includes first housing 4 and second housing 6 that are rotatably connected to each other.

In PC 2 of FIG. 1, first housing 4 includes display 8, and second housing 6 includes keyboard 10. In the present disclosure, in PC 2, a state in which first housing 4 and second housing 6 approach each other by rotation and a display surface of display 8 and a key top of keyboard 10 face each other, is referred to as a closed state (see FIG. 2). On the other hand, a state in which first housing 4 and second housing 6 are rotated about a hinge or the like connecting housings 4 and 6 as a rotation axis making the state to not be in the closed state, for example, a state in which the display surface of display 8 and the key top of keyboard 10 are visually recognizable from the outside, is referred to as an opened state (see FIG. 1). PC 2 can be used by switching between the closed state and the opened state. In PC 2, for example, a predetermined operation of suppressing power consumption is performed in the closed state, such as a process of turning off the display of display 8 and/or a process of shifting to a so-called sleep mode or a sleep state.

First housing 4 further includes, for example, capacitive touch panel 13 that receives a touch operation on the display of display 8. By detecting a change in capacitance of a position or a region caused by various objects such as a finger of a user or a touch pen approaching touch panel 13, touch panel 13 can detect the position or the region where the object has approached. In addition, second housing 6 includes, for example, touch pad 12 that receives a touch operation similarly to touch panel 13, and may further include various operation buttons at an outer edge of touch pad 12. In PC 2, keyboard 10, touch pad 12, touch panel 13 on display 8, and the like constitute an input interface for inputting various user operations. The input interface of PC 2 may include a terminal to which an external input device such as a mouse is connected.

As illustrated in FIG. 1, PC 2 further includes illuminance sensor 14, magnetism generator 16, and magnetic sensor 18.

Illuminance sensor 14 is a sensor that detects illuminance indicating surrounding brightness according to the amount of received light, and generates, for example, a detection signal indicating an illuminance value corresponding to the magnitude of the detected illuminance. In an example of FIG. 1, illuminance sensor 14 is provided in first housing 4, and is disposed so as to detect illuminance on a display surface side of display 8. When PC 2 is in the closed state as illustrated in FIG. 2, the amount of light received by illuminance sensor 14 decreases, and the illuminance value lower than that in the opened state, as illustrated in FIG. 1, is detected.

Magnetism generator 16 is a member that externally generates magnetism (magnetic field). As magnetism generator 16, a permanent magnet that constantly generates magnetism without receiving energy from the outside, an electromagnet that temporarily generates magnetism by receiving energy from the outside, or the like can be used. In the present exemplary embodiment, the permanent magnet is used as magnetism generator 16. In the example of FIG. 1, magnetism generator 16 is provided in first housing 4, and is disposed near an upper left end of display 8.

Magnetic sensor 18 is a sensor that detects magnetism generated by magnetism generator 16, and generates, for example, a detection signal indicating whether magnetism is detected. Magnetic sensor 18 is disposed to be able to detect magnetism from magnetism generator 16 in the closed state of PC 2. For example, in PC 2 illustrated in FIGS. 1 and 2, magnetism generator 16 and magnetic sensor 18 are disposed so as to face each other when first housing 4 and second housing 6 approach each other in the closed state. Note that magnetic sensor 18 is not limited to be disposed to face magnetism generator 16 as long as magnetism of magnetism generator 16 can be detected in the closed state.

When magnetism generator 16 approaches magnetic sensor 18 as in the closed state of PC 2 illustrated in FIG. 2, magnetic sensor 18 detects magnetism of magnetism generator 16. On the other hand, when magnetism generator 16 is located at a position away from magnetic sensor 18 as in the opened state in FIG. 1, magnetic sensor 18 does not detect magnetism of magnetism generator 16.

In the example of FIG. 1, in PC 2, illuminance sensor 14 is disposed near an upper center of first housing 4, magnetism generator 16 is disposed at an upper left side of first housing 4, and magnetic sensor 18 is disposed at a lower left side of second housing 6. As described above, illuminance sensor 14, magnetism generator 16, and magnetic sensor 18 can be generally incorporated in an outer edge portions of first housing 4 or second housing 6 due to, for example, restriction of mounting space in PC 2. However, the disposition illustrated in FIG. 1 is an example, and the disposition is not limited thereto.

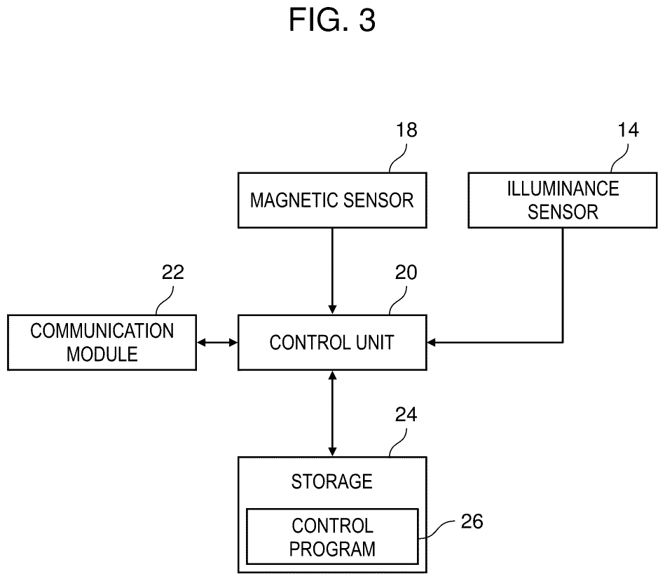

FIG. 3 is a diagram illustrating an internal configuration of PC 2. PC 2 incorporates control unit 20, communication module 22, and storage 24. In PC 2, illuminance sensor 14, magnetic sensor 18, communication module 22, and storage 24 are electrically connected to control unit 20.

Control unit 20 controls the operation of PC 2 according to detection results of illuminance sensor 14 and magnetic sensor 18. Specifically, as described later, control unit 20 determines whether first housing 4 and second housing 6 of PC 2 are in the closed state based on the respective detection signals transmitted from illuminance sensor 14 and magnetic sensor 18. For example, when determining that PC 2 is in the closed state, control unit 20 executes a predetermined operation corresponding to the closed state as described above.

Control unit 20 is, for example, an embedded controller (EC) such as a microcomputer that executes a program. Control unit 20 may include a central processing unit (CPU), a memory (ROM and/or RAM), a timer circuit, an input/output terminal, and the like. Control unit 20 is stored inside second housing 6, for example. Control unit 20 may be configured by a hard-wired electronic circuit.

Communication module 22 is a circuit that performs communication in compliance with various communication standards. Examples of the standard include IEEE802.11, Wi-Fi (registered trademark), Bluetooth (registered trademark), 4G, 5G, and the like. Communication module 22 is connectable to, for example, a communication network such as the Internet. PC 2 may communicate with another device through an access point via communication module 22, or may directly communicate with another device. Communication module 22 may perform wired communication in accordance with a standard such as Ethernet (registered trademark) and/or USB. Communication module 22 may include connection terminals for various wired communications.

Storage 24 is a storage medium that stores programs and data, and stores, for example, control program 26 that is executed by control unit 20 to control the operation of PC 2. Storage 24 is configured as, for example, a magnetic storage such as a hard disk drive (HDD), a semiconductor storage such as a solid state drive (SSD), or an optical storage such as an optical disk drive. Storage 24 may include a temporary storage element configured by, for example, a DRAM or an SRAM, or may function as an internal memory of control unit 20. Control program 26 may be acquired from the outside of PC 2 through the network via communication module 22.

### 2. Operation

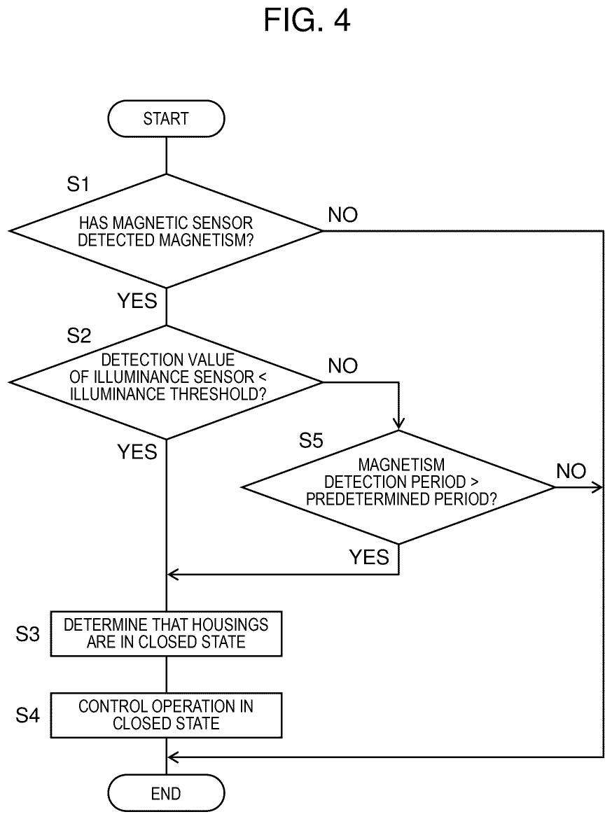

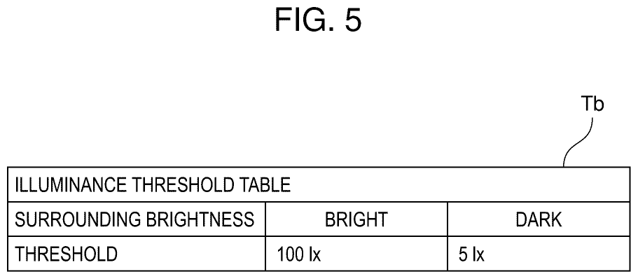

The operation of PC 2 configured as described above will be described with reference to FIGS. 4 and 5.

### 2-1. Outline

When PC 2 is switched to the closed state during use in the opened state, PC 2 executes a predetermined operation such as turning off the display of display 8. At this time, PC 2 determines whether first housing 4 and second housing 6 are in the closed state according to the detection results of magnetic sensor 18 and the like. If housings 4, 6 are determined to be in the closed state according to only the detection result of whether magnetic sensor 18 has detected magnetism, there is a concern that the opened state may be erroneously determined as the closed state in a case where magnetism from an external magnetism generation source different from magnetism generator 16 is detected. For example, while the user wears a wristwatch or wristwatch-type terminal with a magnetic band, or the like and operates PC 2, magnetic sensor 18 may detect magnetism by the magnetic band and erroneously determine that housings 4, 6 are in the closed state. As a result, an operation corresponding to the closed state, for example, turning off the display of display 8 may be performed at a timing not intended by the user, which may cause inconvenience.

Here, PC 2 of the present exemplary embodiment determines whether first housing 4 and second housing 6 are in the closed state according to the detection results of illuminance sensor 14 and magnetic sensor 18. For example, in a case where magnetism is detected by magnetic sensor 18 and illuminance detected by illuminance sensor 14 is less than a predetermined value, PC 2 determines that housings 4, 6 are in the closed state. Accordingly, even when magnetic sensor 18 detects magnetism from a unit other than magnetism generator 16, erroneous determination of the closed state can be suppressed.

However, when illuminance sensor 14 and magnetic sensor 18 are combinedly used as described above, there may be a case where it is difficult to distinguish between the opened state and the closed state from the detection result of illuminance sensor 14, such as using PC 2 in a dark environment. In such a case, illuminance sensor 14 does not sufficiently function as detection means for determining the closed state separately from magnetic sensor 18, and there is a problem that it is difficult to accurately determine the closed state.

In addition, for example, instead of illuminance sensor 14, in a case where a pressure sensor is mounted on one of first housing 4 and second housing 6 and a pressing member is mounted on the other one of first housing 4 and second housing 6 at a position facing the pressure sensor, determination of the closed state may be made by detecting the pressure from the pressing member with the pressure sensor in the closed state. In this case, the closed state can be determined even when the illuminance difference between the opened state and the closed state is relatively small. However, mounting the pressure sensor and the like on PC 2 as additional members may be difficult to realize from the viewpoint of restrictions on a mounting space and a manufacturing cost and restrictions on an opportunity to add a member after manufacturing and selling PC 2.

Therefore, PC 2 according to the present exemplary embodiment determines whether first housing 4 and second housing 6 are in the closed state not only by combinedly using illuminance sensor 14 and magnetic sensor 18 but also by a period during which magnetic sensor 18 detects magnetism. Accordingly, even in a case where it is difficult to distinguish between the closed state and the opened state from, for example, the detection result of illuminance sensor 14, it is possible to determine whether housings 4, 6 are in the closed state according to the magnetism detection period. For example, in a case where magnetism is continuously detected, there is a high possibility that housings 4, 6 approach each other and are in the closed state. As described above, it is possible to accurately determine the closed state while suppressing erroneous determination of the closed state in PC 2.

Furthermore, in PC 2, for example, in a case where illuminance sensor 14 is mounted for luminance adjustment or the like of display 8 corresponding to surrounding brightness or darkness, if the function of determination as described above is provided as control program 26, the operation of determining the closed state can be improved without adding a new member. Hereinafter, a closed state determination process for realizing the determination operation in PC 2 will be described in detail.

### 2-2. Closed State Determination Process

In PC 2 of the present exemplary embodiment, the closed state determination process as described above will be described with reference to FIGS. 4 and 5.

FIG. 4 is a flowchart indicating the closed state determination process of PC 2 of the present exemplary embodiment. Each process in this flowchart is executed by control unit 20 of PC 2. The process in this flowchart is started by execution of control program 26 in PC 2, for example, and is repeatedly executed at a predetermined cycle.

First, control unit 20 determines whether magnetic sensor 18 has detected magnetism based on a detection result of magnetic sensor 18 (S1). Specifically, control unit 20 determines that magnetism has been detected in a case of receiving a magnetic detection signal from magnetic sensor 18, and determines that magnetism has not been detected in a case of not receiving the magnetic detection signal.

In a case where magnetic sensor 18 detects magnetism (YES in S1), control unit 20 determines whether a detection value by illuminance sensor 14, that is, an illuminance value, is less than a predetermined threshold based on a detection result of illuminance sensor 14 (S2). Control unit 20 receives a detection signal including the illuminance value from illuminance sensor 14 according to, for example, a detection cycle of illuminance sensor 14. The predetermined threshold is set in consideration of, for example, an assumed use environment of PC 2, and is stored in storage 24.

FIG. 5 is a diagram for describing an illuminance threshold in the closed state determination process. FIG. 5 indicates illuminance threshold table Tb that manages the illuminance threshold. Illuminance threshold table Tb of the present exemplary embodiment stores two types of thresholds corresponding to assumed surrounding brightness of PC 2. In an example of FIG. 5, “100” lux (lx) is set as the threshold in a case where the surroundings are relatively bright, and “5” lx is set as the threshold in a case where the surroundings are relatively dark.

Refer back to FIG. 4. In the present exemplary embodiment, PC 2 causes display 8 to display, for example, a menu screen on which the user can select the illuminance threshold, and receives a user operation of selecting the threshold with touch panel 13, keyboard 10, touch pad 12, or other input interfaces. Control unit 20 makes the determination in step S2 by, for example, comparing the threshold selected by the user operation from illuminance threshold table Tb with the illuminance value indicated by the detection signal received from illuminance sensor 14.

In a case where the illuminance value detected by illuminance sensor 14 is less than the threshold (YES in S2), control unit 20 determines that first housing 4 and second housing 6 are in a closed state (S3). Thereafter, control unit 20 controls PC 2 so as to perform an operation corresponding to the closed state such as turning off the display of display 8 (S4).

On the other hand, in a case where the illuminance value detected by illuminance sensor 14 is not less than the threshold (NO in S2), control unit 20 determines whether a detection period during which magnetism is detected is longer than a predetermined period based on the detection signal from magnetic sensor 18 (S5). At this time, in addition to the case where the detected illuminance value is greater than or equal to the threshold, for example, even in a case where illuminance sensor 14 cannot detect illuminance, control unit 20 may proceed to step S5 determining that the illuminance value is not less than the threshold (NO in S2). In step S5, for example, in a case of continuously receiving the detection signal of magnetic sensor 18 in the detection cycle of magnetic sensor 18, or the like, until the lapse of the predetermined period from the reception of the detection signal of magnetic sensor 18 in step S1, control unit 20 determines that the detection period is longer than the predetermined period (YES in S5).

For example, assuming a state in which a magnetism generation source (for example, a wristwatch-type terminal of the user) other than magnetism generator 16 approaches magnetic sensor 18, the predetermined period in step S5 is set in advance to be longer than or equal to a period in which such a state is assumed to continue, and is stored in storage 24. For example, in PC 2 of the present exemplary embodiment, the predetermined period can be set on the menu screen or the like on display 8. The predetermined period may be selected from predetermined options such as “1 min, 3 min, 5 min, or 10 min” according to the user operation using various input interfaces.

In a case where the magnetism detection period is longer than the predetermined period (YES in S5), control unit 20 determines that first housing 4 and second housing 6 are in the closed state (S3), and executes the operation corresponding to the closed state (S4).

On the other hand, in a case where the magnetism detection period is not longer than the predetermined period, that is, less than or equal to the predetermined period (NO in S5), control unit 20 ends the process in this flowchart. In this case, it may be determined that first housing 4 and second housing 6 are in an opened state. In addition, in a case of determining that magnetic sensor 18 does not detect magnetism (NO in S1), control unit 20 ends the process in this flowchart similarly to the case that the magnetism detection period is less than or equal to the predetermined period (NO in S5).

According to the closed state determination process as described above, in a case where magnetism is detected by magnetic sensor 18 (YES in S1) and the illuminance value detected by illuminance sensor 14 is less than the threshold (YES in S2), PC 2 is determined to be in the closed state (S3), and the operation corresponding to the closed state is executed (S4). In this way, in a case where the detection results that can correspond to the closed state are obtained in both magnetic sensor 18 and illuminance sensor 14 (YES in S1 and YES in S2), the operation corresponding to the determination of the closed state can be performed without waiting for the lapse of the predetermined period for the detection of magnetism (S3, S4).

In addition, even when magnetism is detected (YES in S1), in a case where the detected illuminance value is not less than the threshold (NO in S2), it is determined whether magnetic sensor 18 is in the closed state according to the detection period in which magnetism is continuously detected (S5, S3). For example, in a case where the detection period exceeds the predetermined period (YES in S5), PC 2 is determined to be in the closed state (S3). In this way, by using the magnetism detection period by magnetic sensor 18, it is possible to accurately determine the closed state even in a case where it is difficult to determine the closed state from the detection result of illuminance sensor 14, for example, while suppressing erroneous determination of the closed state, as compared with a case where only the presence or absence of detection of magnetism is simply used.

### 3. Effects and the Like

As described above, PC 2 of the present exemplary embodiment is an example of an electronic apparatus in which first housing 4 and second housing 6 (examples of two housings) are rotatably connected, and an opened and closed state corresponding to rotation can be switched. PC 2 includes: magnetism generator 16 provided in first housing 4 as an example of a magnetism generation source provided in one of two housings 4, 6; magnetic sensor 18 provided in second housing 6 different from first housing 4, which includes magnetism generator 16, of two housings 4, 6 and disposed to be able to detect magnetism from magnetism generator 16 in a closed state in which two housings 4, 6 approach each other by rotation; control unit 20 (an example of a control circuit) that determines whether two housings 4, 6 are in the closed state based on at least a detection result of magnetism by magnetic sensor 18; and illuminance sensor 14 (an example of a detector) that is provided in second housing 6 as an example of one of the two housings 4, 6 and detects, separately from magnetic sensor 18, a state that changes according to whether two housings 4, 6 are in the closed state. When magnetism is detected by magnetic sensor 18 (YES in S1), in a case where an illuminance value of the detection result is less than a predetermined threshold (YES in S2), as an example of a case where the detection result by illuminance sensor 14 indicates a predetermined state corresponding to a closed state, control unit 20 determines that two housings 4, 6 are in the closed state (S3), and in a case where the illuminance value of the detection result is not less than the threshold (NO in S2), as an example of a case where the detection result by illuminance sensor 14 indicates a state different from the predetermined state, control unit 20 determines whether two housings 4, 6 are in the closed state according to a detection period during which magnetism is continuously detected by magnetic sensor 18 (S5, S3).

According to PC 2 described above, in a case where magnetism is detected by magnetic sensor 18 (YES in S1) and the detection result of illuminance sensor 14 indicates a state corresponding to the closed state (YES in S2), it is determined that first housing 4 and second housing 6 are in the closed state (S3). On the other hand, even when magnetism is detected by magnetic sensor (YES in S1), in a case where the detection result of illuminance sensor 14 is different from the state corresponding to the closed state (NO in S2), it is determined that housings 4, 6 are in the closed state using the magnetism detection period by magnetic sensor 18 (S5). In this way, by determining whether housings 4, 6 are in the closed state combinedly using the detection result of illuminance sensor 14 in addition to magnetic sensor 18 and according to the magnetism detection period even when it is difficult to determine the closed state from the detection result of illuminance sensor 14, it is possible to accurately determine the closed state while suppressing erroneous determination.

In the present exemplary embodiment, when magnetism is detected by magnetic sensor 18 (YES in S1) and when the detected illuminance value is not less than the threshold (NO in S2), as an example in which the detection result by illuminance sensor 14 indicates a state different from a predetermined state, in a case where the detection period by magnetic sensor 18 exceeds the predetermined period (YES in S5), control unit 20 determines that two housings 4, 6 are in the closed state (S3). Accordingly, for example, even in a case where it is difficult to combinedly use the detection result of illuminance sensor 14 for the determination, it is possible to accurately determine the closed state according to a high possibility of being the closed state when magnetism is continuously detected while suppressing erroneous determination of the closed state due to temporal detection of magnetism by magnetic sensor 18.

In the present exemplary embodiment, illuminance sensor 14, which is an example of a detector, is provided on one of the sides of two housings 4, 6 facing each other in the closed state and detects the surrounding illuminance. A predetermined state corresponding to the closed state is a state in which the illuminance detected by illuminance sensor 14 is less than a predetermined value. Since the illuminance is assumed to be lower in the closed state of the PC 2 than in the opened state thereof, the detection result of illuminance sensor 14 can be used to determine the closed state, for example, based on the predetermined value of the illuminance corresponding to the closed state (S2).

In the present exemplary embodiment, PC 2 further includes storage 24 that stores a plurality of thresholds corresponding to the surrounding illuminance of PC 2 as candidates for the predetermined value of the illuminance. As indicated in illuminance threshold table Tb of FIG. 5, the plurality of thresholds includes a first threshold (for example, “100” lx) and a second threshold (for example, “5” lx) smaller than the first threshold. Control unit 20 determines whether the illuminance detected by illuminance sensor 14 is less than the predetermined value based on one threshold among the plurality of thresholds (S2). Accordingly, it is possible to accurately determine the closed state based on the detection result of illuminance sensor 14 using the threshold corresponding to the surrounding illuminance of PC 2 from the plurality of thresholds.

In the present exemplary embodiment, PC 2 further includes keyboard 10, touch pad 12, touch panel 13 on display 8, and the like as examples of an input interface for inputting a user operation for selecting one threshold from the plurality of thresholds as indicated in illuminance threshold table Tb. The predetermined value of the illuminance in the determination in step S2 is one threshold selected by the user operation. Accordingly, it is possible to accurately determine the closed state based on the detection result of illuminance sensor 14 using the threshold selected by the user according to, for example, the use environment of PC 2, as the predetermined value of the illuminance.

In the present exemplary embodiment, when determining that two housings 4, 6 are in the closed state (S3), control unit 20 performs a predetermined operation in PC 2 corresponding to the closed state (S4). For example, as described above, the display of display 8 is turned off. By suppressing erroneous determination of the closed state and improving determination accuracy, such a predetermined operation can be easily performed at an appropriate timing, and the convenience of the user can be improved in PC 2.

In the present exemplary embodiment, control program 26 is an example of a program for controlling PC 2 (an example of an electronic apparatus) in which two housings 4, 6 are rotatably connected and an opened and closed state corresponding to rotation can be switched. As being executed by control unit 20 (an example of a control circuit) of PC 2, when magnetism is detected by magnetic sensor 18 (YES in S1), in a case where the detection result by illuminance sensor 14 indicates a predetermined state corresponding to the closed state (YES in S2), control program 26 causes control unit 20 to determine that two housings 4, 6 are in the closed state (S3), and in a case where the detection result by illuminance sensor 14 indicates a state different from the predetermined state (NO in S2), control program 26 causes control unit 20 to determine whether two housings 4, 6 are in the closed state according to the detection period during which magnetism is continuously detected by magnetic sensor 18 (S5, S3). Accordingly, PC 2 can be controlled to accurately determine the closed state while suppressing erroneous determination of the closed state.

### Second Exemplary Embodiment

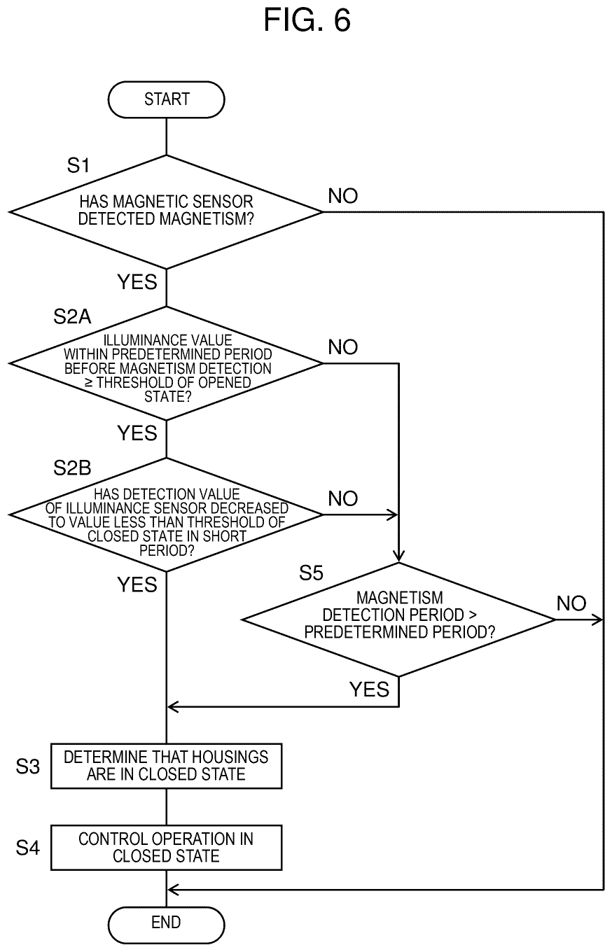

Hereinafter, a second exemplary embodiment will be described with reference to FIG. 6. In the first exemplary embodiment, PC 2 using the illuminance value instantaneously detected by the illuminance sensor 14 in the closed state determination process (FIG. 4) has been described (S2). In the second exemplary embodiment, PC 2 that performs a closed state determination process based on a temporal change of an illuminance value instead of the instantaneous illuminance value will be described.

Hereinafter, PC 2 according to the present exemplary embodiment will be described, but descriptions of a configuration and operation similar to those of PC 2 according to the first exemplary embodiment will be appropriately omitted.

FIG. 6 is a flowchart indicating the closed state determination process of PC 2 of the second exemplary embodiment. The flowchart of FIG. 6 starts, for example, in a state where illuminance sensor 14 repeats detection of the illuminance values in a predetermined detection cycle. Hereinafter, the description similar to that of FIG. 4 in the first exemplary embodiment will be appropriately omitted.

In the closed state determination process in the present exemplary embodiment, control unit 20 performs a process for detecting a steep temporal change in the illuminance value (S2A, S2B) instead of the determination as to whether the illuminance value is less than the threshold (S2) in the first exemplary embodiment. For example, in a case where magnetism is detected (YES in S1) and the illuminance value changes steeply (YES in S2A, YES in S2B), it is determined that first housing 4 and second housing 6 are in a closed state (S3).

For example, in a case where magnetism is detected by magnetic sensor 18 (YES in S1), control unit 20 of the present exemplary embodiment determines whether each of the illuminance values detected by illuminance sensor 14 over a predetermined period (for example, 1 minute) immediately before the detection of magnetism is greater than or equal to a threshold of an opened state (S2A). Assuming that the surroundings of PC 2 are relatively bright, the threshold of the opened state is set to a value higher than a threshold of the closed state in step S2B to be described later, and is, for example, “1000” lx. For example, PC 2 sequentially retains the illuminance values detected by illuminance sensor 14 over the predetermined period, in storage 24 or the like. In this way, it is determined whether the illuminance values detected within the predetermined period are continuously greater than or equal to the threshold of the opened state (S2A).

In a case where the illuminance values within the predetermined period are continuously greater than or equal to the threshold of the opened state (YES in S2A), control unit 20 determines whether the illuminance values detected by illuminance sensor 14 in a subsequent short period (for example, several tens of seconds) decrease to a value less than the threshold of the closed state (S2B). The threshold of the closed state is set to be less than or equal to the threshold of the opened state, and is, for example, “100” lx similar to the threshold used in step S2 of the closed state determination process (FIG. 4) in the first exemplary embodiment. The determination in step S2B is made based on a detection signal from illuminance sensor 14, for example, similarly in step S2 of FIG. 4.

For example, after the lapse of the predetermined period in step S2A, when the illuminance value less than the threshold of the closed state is detected in a predetermined short period shorter than the predetermined period, control unit 20 determines that the detected illuminance value has decreased in a short period (YES in S2B). In this way, from a state in which the relatively bright illuminance value corresponding to the open state has been continued (YES in S2A), it is determined whether the detected illuminance value has darkly changed in a short period according to the switching to the closed state (S2B).

In a case where the detected illuminance value has changed to a value less than the threshold of the closed state in the short period described above (YES in S2B), control unit 20 determines that first housing 4 and second housing 6 are in the closed state (S3).

On the other hand, in a case where the illuminance value detected in the short period described above is not less than the threshold of the closed state, that is, greater than or equal to the threshold of the closed state (NO in S2B), control unit 20 determines whether a magnetism detection period after step S1 is continued exceeding the predetermined period (S5). In addition, also in a case where the illuminance values within the predetermined period are not continuously greater than or equal to the threshold of the opened state, that is, less than the threshold of the opened state (NO in S2A), control unit 20 similarly performs the determination in step S5.

According to the closed state determination process in the second exemplary embodiment as described above, after the illuminance values greater than or equal to the threshold of the opened state are detected over the predetermined period before the magnetism detection (YES in S2A), in a case where the illuminance value changes to a value less than the threshold of the closed state in a short period (YES in S2B), PC 2 is determined to be in the closed state (S3). As described above, in addition to the detection of magnetism by magnetic sensor 18, it can be determined that PC 2 has changed from the opened state to the closed state according to the steep change in illuminance by illuminance sensor 14 from the continuous relatively bright state to the dark state. Accordingly, for example, from the viewpoint of suppressing erroneous determination of the closed state based on the detection result of magnetic sensor 18, the determination accuracy of the closed state can be further enhanced when the detection result of illuminance sensor 14 is combinedly used.

In PC 2 of the present exemplary embodiment, the threshold of the opened state and the threshold of the closed state used in steps S2A and S2B described above may be selectable by the user from predetermined candidates, similarly to the thresholds in step S2 of the first exemplary embodiment, for example. In addition, in PC 2, for example, the detection result of illuminance sensor 14 may be monitored before the process in step S1 of FIG. 6 is executed, and the determination of step S2B may be performed in a case where magnetism is detected during detection of an illuminance value greater than or equal to the threshold in the opened state over a predetermined period.

As described above, in PC 2 according to the present exemplary embodiment, after illuminance sensor 14 continuously detects illuminance higher than the threshold of the opened state (an example of illuminance higher than the predetermined value) for a predetermined period or more (YES in S2A), in a case where illuminance less than the threshold of the closed state, which is smaller than the threshold of the opened state, (an example of illuminance less than the threshold of the opened stat) is detected (YES in S2B), control unit 20 determines that two housings 4, 6 are in the closed state (S3). Accordingly, for example, it is possible to determine the closed state with higher accuracy according to the fact that the illuminance may decrease steeply from the continuously and relatively high state when PC 2 is switched from the opened state to the closed state.

### Other Exemplary Embodiments

As described above, the first and second exemplary embodiments have been described as the examples of the technique disclosed in the present application. However, the technique according to the present disclosure is not limited to these exemplary embodiments, and is applicable to exemplary embodiments in which changes, replacements, additions, omissions, or the like are made as appropriate. Other exemplary embodiments will be described below.

In the first exemplary embodiment described above, the example has been described in which, in the closed state determination process (FIG. 4), the illuminance threshold used in step S2 can be selected by the user of PC 2 from threshold candidates according to the surrounding brightness as indicated in illuminance threshold table Tb of FIG. 5. PC 2 of the present exemplary embodiment may automatically select an illuminance threshold. For example, control unit 20 retains a detection result of illuminance values in a predetermined period (for example, 1 minute), and when magnetism is detected in a closed state determination process (YES in S1), control unit 20 calculates a time average of the illuminance values over the period before the detection of magnetism. Control unit 20 may determine whether the surroundings of PC 2 are in a relatively bright or dark environment from the time average of the illuminance values, that is, the average illuminance, and select a threshold corresponding to the determination result from illuminance threshold table Tb.

For example, in the present exemplary embodiment, control unit 20 may select the threshold value “100” lx for a relatively bright case when the average illuminance is higher than or equal to a predetermined value and may select the threshold value “5” lx for a relatively dark case when the average illuminance is less than the predetermined value, and use the threshold value for the determination in step S2. The predetermined value of the average illuminance may be, for example, “200” lx.

In the respective exemplary embodiments described above, the examples have been described in which, in the closed state determination process, the determination is made whether the state is the closed state (S3) or the determination is made by the magnetism detection period (S5), according to the comparison result between the illuminance value detected by illuminance sensor 14 and the predetermined threshold (S2 in FIG. 4, S2A and S2B in FIG. 6). In the present exemplary embodiment, determination of the closed state or the like may be performed according to, for example, a temporal change in illuminance value immediately before detection of magnetism without using a particular threshold.

In the present exemplary embodiment, for example, control unit 20 calculates a time average of illuminance values over a predetermined period (for example, 1 minute) immediately before detection of magnetism. When an illuminance value detected thereafter changes from the calculated average illuminance by a predetermined ratio, control unit 20 may determine that the state is a closed state (S3) similarly to the cases where the condition of the threshold in the above exemplary embodiments is satisfied (YES in S2, or YES in S2A and YES in S2B). Accordingly, it is possible to more flexibly determine the closed state according to the surrounding illuminance of PC 2. In addition, by using the amount of change from the average illuminance over the predetermined period, for example, even in a case where housings 4, 6 gradually approach each other from the opened state to the closed state, the closed state can be accurately determined.

In the respective exemplary embodiments described above, the examples have been described in which, in the closed state determination process (FIG. 4 or FIG. 6), illuminance sensor 14 and magnetic sensor 18 are combinedly used even if there is no particular user setting or the like, but the determination process is not limited thereto. For example, in the present exemplary embodiment, it may be selectable by a user whether to combinedly use illuminance sensor 14 in a determination process in PC 2 by using a menu screen or the like. In a case where illuminance sensor 14 is not combinedly used, when magnetic sensor 18 detects magnetism (YES in S1), control unit 20 may proceed to determination of whether a magnetism detection period exceeds a predetermined period (S5).

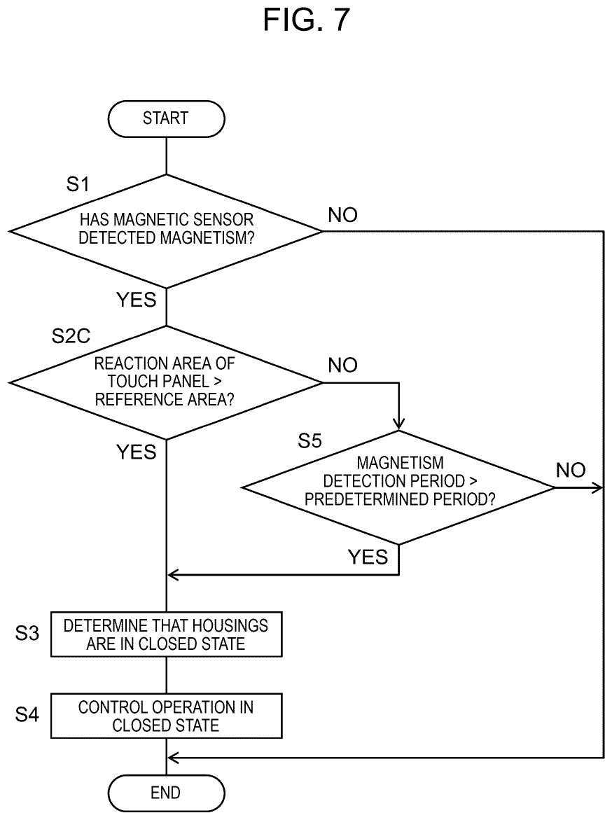

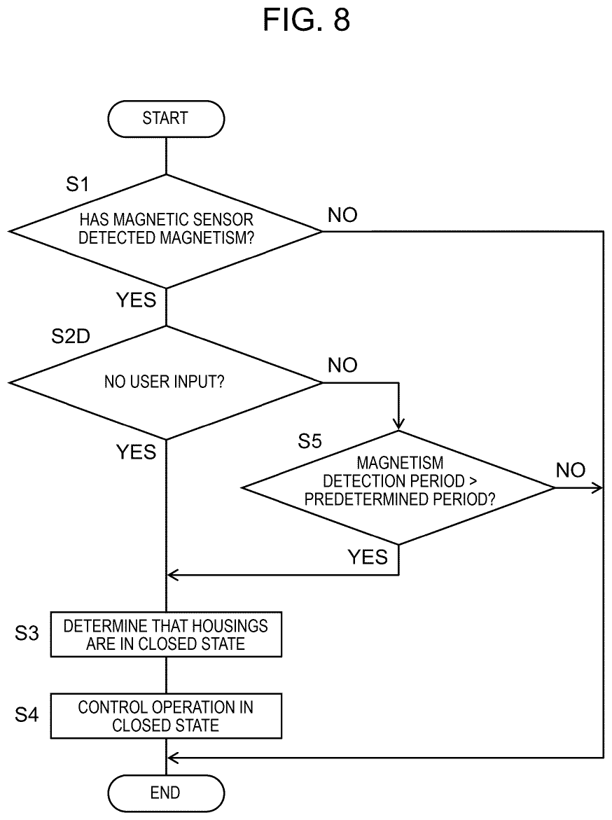

In the respective exemplary embodiments described above, the examples have been described in which, in the closed state determination process, PC 2 combinedly uses the detection result of illuminance sensor 14 in addition to the detection result of magnetic sensor 18. In the present exemplary embodiment, detection means combinedly used with a detection result of magnetic sensor 18 is not limited to illuminance sensor 14. A closed state determination process according to such a modification will be described with reference to FIGS. 7 and 8.

FIG. 7 is a flowchart indicating a closed state determination process in a first modification. In the present modification, instead of the detection result of illuminance sensor 14, an area of a region detected by touch panel 13 (an example of a detector) superimposed on display 8 is used (S2C). In the closed state illustrated in FIG. 2, when keyboard 10 approaches display 8, the capacitive touch panel can react. At this time, it is considered that touch panel 13 reacts in a wider range than at the time of being operated by the user.

In the present modification, in addition to detection of magnetism by magnetic sensor 18 (YES in S1), control unit 20 acquires a reaction area of touch panel 13 and compares the reaction area with a predetermined reference area (S2C). In a case where the reaction area is larger than the reference area (YES in S2C), control unit 20 determines that the state is a closed state (S3). Such detection of the reaction area of touch panel 13 may be used instead of the detection result of illuminance sensor 14 in the respective exemplary embodiments (for example, S2 of FIG. 4, and S2A and S2B of FIG. 6) as illustrated in FIG. 7, or may be used in combination with the detection result of illuminance sensor 14.

FIG. 8 is a flowchart indicating a closed state determination process in a second modification. In the present modification, instead of the detection result of illuminance sensor 14, a detection result of magnetic sensor 18 and input states from various input interfaces (examples of detectors) such as keyboard 10, touch pad 12, touch panel 13, and a mouse connected to PC 2 are combinedly used to determine that the state is a closed state (S2D). In the closed state of PC 2, it is assumed that user operations input in an opened state are stopped in these input devices.

In the present modification, control unit 20 monitors, for example, the input states to the input interfaces. When magnetism is detected (YES in S1), in a case where no user operation is input immediately before magnetism is detected (alternatively, a state in which no input is performed for a predetermined period immediately before detection continues) (YES in S2D), control unit 20 determines that housings 4, 6 are in a closed state (S3). Such input states of PC 2 may be used instead of the detection result of illuminance sensor 14 in the respective exemplary embodiments as illustrated in FIG. 8, or may be used in combination with the detection result of illuminance sensor 14.

The closed state determination processes according to the modifications as described above also enable PC 2 to accurately determine the closed state while suppressing erroneous determination of the closed state similarly to the respective exemplary embodiments described above.

In the present disclosure, preferred exemplary embodiments of the disclosed technique have been described with reference to the accompanying drawings, but various modifications and corrections are obvious to those skilled in the art. Such modifications and corrections are to be understood as being included within the scope of the present disclosure as set forth in the appended claims, unless departing from the scope of the present disclosure. In addition, changes in the combination and the order of elements in the respective exemplary embodiments can be achieved without departing from the scope and ideas of the present disclosure.

Note that any exemplary embodiments and modifications of the respective exemplary embodiments and modifications described above may be appropriately combined to achieve effects of the exemplary embodiments and modifications.

### Aspects of Present Disclosure

As described above, the present disclosure includes the following aspects.

### (First Aspect)

An electronic apparatus in which two housings are rotatably connected and an opened and closed state corresponding to rotation is switchable, the electronic apparatus including:
a magnetism generation source provided in one of the two housings;
a magnetic sensor provided in another housing different from the one of the two housings, and disposed to be able to detect magnetism from the magnetism generation source in a closed state in which the two housings approach each other by rotation;
a control circuit that determines whether the two housings are in the closed state based on at least a detection result of magnetism by the magnetic sensor; and
a detector that is provided in one of the two housings, and detects, separately from the magnetic sensor, a state that changes according to whether the two housings are in the closed state,
in which when magnetism is detected by the magnetic sensor, the control circuit
determines that the two housings are in the closed state in a case where a detection result by the detector indicates a predetermined state corresponding to the closed state, and
determines whether the two housings are in the closed state according to a detection period during which magnetism is continuously detected by the magnetic sensor in a case where a detection result by the detector indicates a state different from the predetermined state.

### (Second Aspect)

The electronic apparatus according to the first aspect, in which
when magnetism is detected by the magnetic sensor and a detection result by the detector indicates a state different from the predetermined state, the control circuit
determines that the two housings are in the closed state in a case where the detection period by the magnetic sensor exceeds a predetermined period.

### (Third Aspect)

The electronic apparatus according to the first or second aspect, in which
the detector includes an illuminance sensor that is provided on one of sides of the two housings facing each other in the closed state and detects surrounding illuminance, and
a predetermined state corresponding to the closed state regarding the illuminance sensor is a state in which illuminance detected by the illuminance sensor is less than a predetermined value.

### (Fourth Aspect)

The electronic apparatus according to the third aspect, further including a storage that stores, as candidates of the predetermined value, a plurality of thresholds corresponding to surrounding illuminance of the electronic apparatus,
in which the plurality of thresholds includes a first threshold and a second threshold smaller than the first threshold, and
the control circuit determines whether illuminance detected by the illuminance sensor is less than the predetermined value based on one threshold among the plurality of thresholds.

### (Fifth Aspect)

The electronic apparatus according to the fourth aspect, further including an input interface for inputting a user operation of selecting one threshold from the plurality of thresholds,
in which the predetermined value is one threshold selected by the user operation.

### (Sixth Aspect)

The electronic apparatus according to any one of the third to fifth aspects, in which the control circuit determines that the two housings are in the closed state in a case where illuminance less than the predetermined value is detected by the illuminance sensor after illuminance higher than the predetermined value is continuously detected for a predetermined period or more.

### (Seventh Aspect)

The electronic apparatus according to any one of the first to sixth aspects, in which when determining that the two housings are in the closed state, the control circuit performs a predetermined operation in the electronic apparatus corresponding to the closed state.

### (Eighth Aspect)

The electronic apparatus according to any one of the first to seventh aspects, in which
the detector includes a capacitive touch panel that detects a region where an object has approached, and
a predetermined state corresponding to the closed state regarding the touch panel is a state in which an area of a region detected by the touch panel is larger than a predetermined area.

### (Ninth Aspect)

The electronic apparatus according to any one of the first to eighth aspects, in which
the detector includes an input interface for inputting a user operation, and
a predetermined state corresponding to the closed state regarding the input interface is a state in which no user operation is input to the input interface immediately before detection of magnetism by the magnetic sensor.

### (Tenth Aspect)

A program for controlling an electronic apparatus in which two housings are rotatably connected and an opened and closed state corresponding to rotation is switchable, the electronic apparatus including:
a magnetism generation source provided in one of the two housings;
a magnetic sensor provided in another housing different from the one of the two housings, and disposed to be able to detect magnetism from the magnetism generation source in a closed state in which the two housings approach each other by rotation;
a control circuit that executes the program to determine whether the two housings are in the closed state based on at least a detection result of magnetism by the magnetic sensor; and
a detector that is provided in one of the two housings, and detects, separately from the magnetic sensor, a state that changes according to whether the two housings are in the closed state,
when magnetism is detected by the magnetic sensor, the program causing, when executed by the control circuit, the control circuit to:
determine that the two housings are in the closed state in a case where a detection result by the detector indicates a predetermined state corresponding to the closed state, and
determine whether the two housings are in the closed state according to a magnetism detection period by the magnetic sensor in a case where a detection result by the detector indicates a state different from the predetermined state.

### INDUSTRIAL APPLICABILITY

The present disclosure is applicable to a technique for determining a closed state of two housings approaching each other in an electronic apparatus in which the two housings are rotatably connected and an opened and closed state corresponding to rotation can be switched.

### REFERENCE MARKS IN THE DRAWINGS

2 PC
4 first housing
6 second housing
8 display
10 keyboard
12 touch pad
13 touch panel
14 illuminance sensor
16 magnetism generator
18 magnetic sensor
20 control unit
22 communication module
24 storage
26 control program
Tb illuminance threshold table

1. An electronic apparatus in which two housings are rotatably connected and an opened and closed state corresponding to rotation is switchable, the electronic apparatus comprising:
a magnetism generation source provided in one of the two housings;
a magnetic sensor provided in another housing different from the one of the two housings, and disposed to be able to detect magnetism from the magnetism generation source in a closed state in which the two housings approach each other by rotation;
a control circuit that determines whether the two housings are in the closed state based on at least a detection result of magnetism by the magnetic sensor; and
a detector that is provided in one of the two housings, and detects, separately from the magnetic sensor, a state that changes according to whether the two housings are in the closed state,
wherein when magnetism is detected by the magnetic sensor, the control circuit
determines that the two housings are in the closed state in a case where a detection result by the detector indicates a predetermined state corresponding to the closed state, and
determines whether the two housings are in the closed state according to a detection period during which magnetism is continuously detected by the magnetic sensor in a case where a detection result by the detector indicates a state different from the predetermined state.

2. The electronic apparatus according to claim 1, wherein
when magnetism is detected by the magnetic sensor and a detection result by the detector indicates a state different from the predetermined state, the control circuit
determines that the two housings are in the closed state in a case where the detection period by the magnetic sensor exceeds a predetermined period.

3. The electronic apparatus according to claim 1, wherein
the detector includes an illuminance sensor that is provided on one of sides of the two housings facing each other in the closed state and detects surrounding illuminance, and
a predetermined state corresponding to the closed state regarding the illuminance sensor is a state in which illuminance detected by the illuminance sensor is less than a predetermined value.

4. The electronic apparatus according to claim 3, further comprising a storage that stores, as candidates of the predetermined value, a plurality of thresholds corresponding to surrounding illuminance of the electronic apparatus,
wherein the plurality of thresholds includes a first threshold and a second threshold smaller than the first threshold, and
the control circuit determines whether illuminance detected by the illuminance sensor is less than the predetermined value based on one threshold among the plurality of thresholds.

5. The electronic apparatus according to claim 4, further comprising an input interface for inputting a user operation of selecting one threshold from the plurality of thresholds,
wherein the predetermined value is one threshold selected by the user operation.

6. The electronic apparatus according to claim 3, wherein the control circuit determines that the two housings are in the closed state in a case where illuminance less than the predetermined value is detected by the illuminance sensor after illuminance higher than the predetermined value is continuously detected for a predetermined period or more.

7. The electronic apparatus according to claim 1, wherein when determining that the two housings are in the closed state, the control circuit performs a predetermined operation in the electronic apparatus corresponding to the closed state.

8. The electronic apparatus according to claim 1, wherein
the detector includes a capacitive touch panel that detects a region where an object has approached, and
a predetermined state corresponding to the closed state regarding the touch panel is a state in which an area of a region detected by the touch panel is larger than a predetermined area.

9. The electronic apparatus according to claim 1, wherein
the detector includes an input interface for inputting a user operation, and
a predetermined state corresponding to the closed state regarding the input interface is a state in which no user operation is input to the input interface immediately before detection of magnetism by the magnetic sensor.

10. A program for controlling an electronic apparatus in which two housings are rotatably connected and an opened and closed state corresponding to rotation is switchable, the electronic apparatus including:
a magnetism generation source provided in one of the two housings;
a magnetic sensor provided in another housing different from the one of the two housings, and disposed to be able to detect magnetism from the magnetism generation source in a closed state in which the two housings approach each other by rotation;
a control circuit that executes the program to determine whether the two housings are in the closed state based on at least a detection result of magnetism by the magnetic sensor; and
a detector that is provided in one of the two housings, and detects, separately from the magnetic sensor, a state that changes according to whether the two housings are in the closed state,
when magnetism is detected by the magnetic sensor, the program causing, when executed by the control circuit, the control circuit to:
determine that the two housings are in the closed state in a case where a detection result by the detector indicates a predetermined state corresponding to the closed state, and
determine whether the two housings are in the closed state according to a magnetism detection period by the magnetic sensor in a case where a detection result by the detector indicates a state different from the predetermined state.
